(19) United States
(12) Patent Application Publication
(10) Pub. No.: US 2026/0308813 A1
(43) Pub. Date: Oct. 8, 2026

(54) ADDITIVE MANUFACTURING POLYMERS WITH HIGH METAL INCLUSION CONTENT

(71) Applicant: The Research Foundation for The State University of New York, Binghamton, NY (US)

(72) Inventors: Oscar Abundez Castrejon, Johnson City, NY (US); Jacob Goodman, Westworth Village, TX (US); Scott N. Schiffres, Vestal, NY (US); Pritam Das, Vestal, NY (US)

(21) Appl. No.: 19/177,472

(22) Filed: Apr. 11, 2025

Related U.S. Application Data
(60) Provisional application No. 63/633,033, filed on Apr. 11, 2024.

(51) Int. Cl. D01F 6/94; B22F 10/18; B22F 10/64; B33Y 10/00; B33Y 40/10; B33Y 40/20; B33Y 70/10; B33Y 80/00; D01F 1/10; D01F 6/92; H01F 41/02

(52) U.S. Cl. CPC D01F 6/94; B22F 10/18; B22F 10/64; B33Y 10/00; B33Y 40/10; B33Y 40/20; B33Y 70/10; B33Y 80/00; D01F 1/10; D01F 6/92; H01F 41/0206; B22F 2202/05; B22F 2301/10; B22F 2301/355; B22F 2302/20; B22F 2302/45; B22F 2998/10; B22F 2999/00; D10B 2331/041; D10B 2331/10; D10B 2505/00

(57) ABSTRACT

A metal-polymer composite material for extrusion-based additive manufacturing, comprising a matrix comprising a mixture of an elastomeric thermoplastic and a non-elastomeric thermoplastic; and at least 50 vol. % of a magnetically permeable powder. A method of forming a magnetic core for a planar integrated magnetic device is also provided, comprising: forming a lower portion of the magnetic core by an extrusion additive manufacturing process; placing a circuit board such that the magnetic core extends through apertures of the circuit board; and forming an upper portion of the magnetic core continuous with the lower portion of the magnetic core by the extrusion additive manufacturing process to capture the circuit board. The method forming of the upper portion of the magnetic core may be adaptive to at least one performance measurement obtained during the extrusion additive manufacturing process.

### CROSS REFERENCE TO RELATED APPLICATIONS

The present application is a Non-Provisional of U.S. Provisional Patent Application No. 63/633,033, filed Apr. 11, 2024, the entirety of which is expressly incorporated herein by reference.

### GOVERNMENT SUPPORT CLAUSE

This invention was made with government support under Contract No. DE-SC0021784 awarded by The U.S. Department of Energy. The government has certain rights in the invention.

### FIELD OF THE INVENTION

The present invention relates to polymers having a high included metal particle content, having utility in magnetic, thermal transfer, and sintered metal manufacturing applications.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, the inventors' prior publications relating to the field, academic literature in the field, commercial literature in the field, field-specific dictionaries, lay literature in the field, general purpose dictionaries, and common understanding. Where the issue of interpretation of claim amendments arises, the hierarchy is modified to include arguments presented during the prosecution, relating to an element present in a respective claim, and accepted to overcome a rejection, without retained recourse.

### BACKGROUND OF THE INVENTION

The development of high metal volume fraction fused deposition modeling (FDM) filament with robust mechanical performance has many important applications, including additively manufactured magnetic cores for efficient power conversion, high thermal conductivity polymer-composite printed parts, and more robust green parts for metal sintered FDM.

Metal-polymer composite materials are important in developing technologies, such as AC-DC power converters for green power conversion and storage. The highest efficiency converters use magnetic cores made of laminated nanocrystalline FINEMET ribbons of ~18 microns thick that are shaped (e.g., ‘E’ or ‘I’ shaped). These high-performance cores are currently made of rapidly quenched spun-cast ribbons that are then laminated to make bulk structures. These nanocrystalline/amorphous magnets have low losses owing to their low magnetic hysteresis and electrical isolation between layers. However, these nano-crystalline and amorphous cores require significant manual labor, as laminating the core, cutting segments to get the right total impedance, and winding is typically done by hand. Moreover, these cores are not available in every geometry and impedance desired by circuit designers, and when they are available, they often have large variations in impedance sample-to-sample that require de-tuning of magnetics-containing circuits in order to tolerate the variations.

Additively manufactured magnetic parts with high magnetic permeability are an especially urgent need, especially for low volume production, short term requirements, and need for in-process calibration of properties.

FINEMET®, a Fe—C—Si—Cu—Nb alloy, was originally developed by Hitachi and was originally formed by rapidly quenching through spin casting (ribbon thickness of 18 μm, with a density of 7.3 g/cm³ and later also synthesized by gas atomization.

Achieving high metal volume percentages in an FDM metal-polymer composite is necessary for printing cores of high inductance. The general trend of permeability versus volume percent can be predicted by effective medium theory, which shows a predicted increase in relative permeability going from 50 vol. % to 70 vol. %. However, higher volume percentages are also more viscous and jam and clog the extruder more readily, as well as a more fragile filament and printed parts. Note that the extrusion nozzle may be inductively heated, to provide fast response to changes in viscosity and/or flow rate and thus potentially limit the amount of time that the polymer and magnetic powder are subjected to high temperatures. Similarly, where the polymer is locally heated to achieve a low viscosity, the powder may be more readily physically or magnetically aligned along a preferred axis.

One challenge with FDM printed magnetics and more generally metal-polymer composites is their mechanical fragility. Hanemann et. al. observed an ultimate tensile strength (UTS) for an Acrylonitrile Butadiene Styrene (ABS) matrix with 30 vol. % of Ferrite material of 7.5±1.8 MPa, weaker than pure ABS, and elongation at failure of lower than pure ABS. Several investigations reveal a degree of change when the matrix contains a higher composition of metal or any solid material, this being correlated to the effects of the poly lactic acid's (PLA) melting point and bonds. Another consequence of this low elongation at failure is that polymer-metal composite filaments typically have to be wound around large diameter spools.

Several applications require permeability-specific toroids, which can be physically achieved using the FDM method. Further, the process allows the structure to be deposited around a PCB board, without a requirement of sintering. (Sintering often has caused issues with E-type cores). The conventional method of forming cores employs a small film of polymer solution between each compressed layer, which limits the eddy currents produced. Use of a highly thermal conductive material such as Hexagonal Boron nitride (hBN), permits the thermal conductivity to be increased exponentially [4], [5], [6].

The various implications that are required of the filament imply that a higher vol. % of fill would be required to achieve higher magnetic permeability, higher thermal conductivity, and improvement in certain mechanical properties.

However, using a filament with a high vol. % would introduce several challenges, since the higher vol. % would produce extruding issues due to the high density of the material, requiring an extruder with a stronger motor and torque. The higher the vol. %, the more brittle the filament, which would also make spooling a greater obstacle. Finally, mechanical properties would be different because of the gaps created by the fill particle size, leading to limited ability to fill gaps and infill.

Additive manufacturing (AM) is the process of joining materials to make parts from 3D model data, usually layer by layer, as opposed to subtractive manufacturing and formative manufacturing methodologies. MEX (material extrusion) is any AM process in which material is selectively dispensed through a nozzle or orifice. The feedstock material is forced out of the printer's extruder nozzle and deposited onto the 3D printing platform layer by layer. The most common MEX AM process is fused deposition modeling (FDM), also known as fused filament fabrication (FFF). In FDM, the typical feedstock is a continuous filament of a thermoplastic polymer. This filament is used to print layers of the filament material. The filament is heated at the printer's nozzle to reach a semiliquid state and then extruded on the print platform or on top of previously printed layers. The platform and the previous layers can both function as the print surface. In FDM, thermoplasticity is an essential filament property because this property allows the filaments to soften when heated, to fuse together during printing, and to solidify after printing. FDM has been used to create many different types of magnets in the form of hybrid magnets. Typically, the filament comprises a magnet material powder mixed into a polymer.

Big Area Additive Manufacturing (BAAM) is a gantry-driven extrusion-based AM process developed at DOE's Oak Ridge National Laboratory (ORNL). The BAAM system deposits thermoplastics and customized thermoplastic composites via melt extrusion processing, which enables rapid manufacturing of objects completely unbound by size. Unlike FDM, the BAAM system uses pellets instead of pre-extruded filament feedstock. The BAAM system accepts pellets—magnetic material powder mixed with a polymer—and extrudes them into filament during printing. This in-system compression and extrusion of filament allows a much higher density than that of pre-extruded filaments. The BAAM printing process can also be conducted within a magnetic field, thereby improving the magnetic properties of the resultant magnet because the magnetic field aligns the magnetic domains within the printed object, increasing its anisotropy. The material density of the magnets produced via BAAM can exceed 70 vol. % magnet powder. Traditional FDM has a loading fraction limit of 65 vol. %.

### SUMMARY OF THE INVENTION

A mechanically robust metal-polymer composite is provided for printing of magnetic components using an FDM process. The composite for the FDM process is preferably a PLA-TPU-metal composite filament, having a powder loading of 65 vol. %, 70 vol. %, or higher.

One application for the material is in an FDM process to print a magnetic core on or around a printed circuit board (PCB). The PCB has, for example, lithographed windings, such that the magnetic core and windings form an inductor or transformer.

The present technology enables the use of precise geometries of tunable inductance material around prefabricated PCB windings using fused deposition modelling (FDM) additive manufacturing. The FDM metal-polymer composite filament, the transformer core design, and the adaptive manufacturing process present advances over the prior art.

The preferred filament comprises a polymer mixture of polylactic acid (PLA) and thermoplastic polyurethane (TPU), mixed with up to 70 vol. % of FINEMET® (Fe—C—Si—Cu—Nb). The filament was produced using a blend of pulverized thermoplastic polyurethane (TPU), pulverized and pelletized polylactic acid (PLA), hexagonal boron nitride (hBN), and nanocrystalline FINEMET Fe-based soft magnetic material (Fe—C—Si—Cu—Nb). The material was made from pelletized and pulverized PLA (density of 1.24 g/cm³), pulverized TPU (1.2 g/cm³), and hBN (2.1 g/cm³).

The hBN is optional, and is provided to enhance thermal conductivity. hBN powder made the extrusion of high metal volume percent difficult with typical pinch wheel designs.

The PLA may be replaced in some cases, in whole or in part, with Acrylonitrile Butadiene Styrene (ABS) in the mixture with TPU.

The addition of the flexible TPU polymer to the rigid PLA polymer made the filament more robust for coiling and the green parts stronger than purely PLA-metal composite. The produced material has a relative magnetic permeability of ~20. For example, the range may be 18-22 (±10%), 19-21 (±5%), 19.5-20.5 (±2.5%), or the like.

The material has a thermal conductivity of over 1 W/m-K and can be further increased for purely thermal applications by the use of Cu instead of FINEMET®.

The composite elongation at failure at 60 vol. % metal was 0.12 m/m, compared to the commercially available metal-composite filament at 60 vol. % metal of 0.08 m/m. This formulation therefore improves the printability and robustness of the polymer.

It is therefore an object to provide a metal-polymer composite material for extrusion-based additive manufacturing, comprising: a matrix comprising a mixture of an elastomeric thermoplastic and a non-elastomeric thermoplastic; and at least 35 vol. % of a magnetically permeable powder. The composite material may further comprise 0.01-5 vol. % of hexagonal boron nitride, e.g., 0.1%, 0.1% or 0.5%. The composite may further comprise copper powder.

The metal-polymer composite material may consist essentially of the elastomeric thermoplastic, the non-elastomeric thermoplastic, and the magnetically permeable powder.

The metal-polymer composite material may consist essentially of the elastomeric thermoplastic, the non-elastomeric thermoplastic, the magnetically permeable powder, and between 0.5-5% hexagonal boron nitride.

The metal-polymer composite material may comprise 50 vol. % to 65 vol. % or 65% to 75% magnetically permeable powder.

The metal-polymer composite material may be configured as a continuous 1.75-3 mm diameter filament on a spool.

The magnetically permeable powder may comprise Finemet® Fe—C—Si—Cu—Nb alloy.

The elastomeric thermoplastic may comprise thermoplastic polyurethane (TPU) and the non-elastomeric thermoplastic comprises polylactic acid (PLA).

The metal-polymer composite material may consist essentially of 10-30 vol. % polylactic acid, 15-30 vol. % thermoplastic polyurethane, 35-70 vol. % magnetic powder, and 0-5 vol. % hexagonal boron nitride.

The metal-polymer composite material may have a relative magnetic permeability of about 20 and/or a thermal conductivity of at least 1 W/m-K.

It is also an object to provide a method of forming a magnetic core for a planar integrated magnetic device, comprising: forming a lower portion of the magnetic core by an extrusion additive manufacturing process; placing a circuit board such that the magnetic core extends through apertures of the circuit board; and forming an upper portion of the magnetic core continuous with the lower portion of the magnetic core by the extrusion additive manufacturing process to capture the circuit board.

The extrusion additive manufacturing process may employ a filament comprising a metal-polymer composite material for extrusion-based additive manufacturing, comprising: a matrix comprising an elastomeric thermoplastic and optionally a non-elastomeric thermoplastic, and at least 30 vol. %, at least 35 vol. %, at least 40 vol. %, at least 45 vol. %, at least 50 vol. %, at least 55 vol. %, at least 60 vol. %, at least 65 vol. %, at least 70 vol. %, or at least 75 vol. %, of a magnetically permeable powder.

The magnetic core may be formed of a composition comprising a matrix comprising an elastomeric thermoplastic and a non-elastomeric thermoplastic, and at least 50 vol. % of a magnetically permeable powder.

The method may further comprise adapting at least the forming of the upper portion of the magnetic core to at least one magnetic measurement obtained during the extrusion additive manufacturing process.

The method may further comprise adapting at least the forming of the upper portion of the magnetic core to at least one performance measurement obtained during the extrusion additive manufacturing process.

The at least one performance measurement may comprise an inductance measurement.

The extrusion additive manufacturing process may be continued until a predetermined inductance is achieved.

It is another object to provide a method of forming a metal-polymer composite material for extrusion-based additive manufacturing, comprising: blending pulverized thermoplastic polyurethane (TPU), pulverized and pelletized polylactic acid (PLA), and an amorphous or nanocrystalline soft magnetic material; and extruding the blend into a filament. The extruded filament may be spooled, for example around a 5 cm, 6 cm, 7 cm, 8 cm, 9 cm, or 10 cm inner diameter spool.

The amorphous or nanocrystalline soft magnetic material may be Finemet® Fe—C—Si—Cu —Nb alloy, Metglas amorphous alloy 2605SA1 (Fe₈₁B_{13.5}S_{3.5}C), Metglas 2826 MB Amorphous Alloy (Fe₄₀Ni₄₀Mo₄B₁₆), Vitroperm 500F (Nanocrystalline Fe-based alloy) with B, Si, Nb, Cu, or the like.

It is a further object to provide a polymer composite material for extrusion-based additive manufacturing, comprising: a matrix comprising a mixture of at least 10 vol. % of the matrix of each an elastomeric thermoplastic and a non-elastomeric thermoplastic; and at least 35 vol. % of a non-polymer powder.

The polymer composite may be configured as a continuous filament on a spool. The polymer composite material may further comprise 0.01-5 vol. % of hexagonal boron nitride wherein the non-polymer powder is sinterable, and the polymer composite material is adapted to be debindered and sintered.

The non-polymer powder may comprise copper powder, Finemet® Fe—C—Si—Cu—Nb alloy powder, The amorphous or nanocrystalline soft magnetic material may be Finemet® Fe—C—Si—Cu —Nb alloy, Metglas amorphous alloy 2605SA1 (Fe₈₁B_{13.5}S_{3.5}C), Metglas 2826 MB Amorphous Alloy (Fe₄₀Ni₄₀Mo₄B₁₆), Vitroperm 500F (Nanocrystalline Fe-based alloy) with B, Si, Nb, Cu, boron nitride, diamond, iron, ceramic, etc.

The polymer composite material may consist essentially of the elastomeric thermoplastic, the non-elastomeric thermoplastic, and a magnetically permeable powder. The non-polymer powder may comprise 50 vol. % to 65 vol. % magnetically permeable powder. The non-polymer powder may comprise 65 vol. % to 75 vol. % magnetically permeable powder.

The polymer composite material may consist essentially of the elastomeric thermoplastic, the non-elastomeric thermoplastic, the non-polymer powder comprising a magnetically permeable powder, and between 0.5-5% hexagonal boron nitride.

The elastomeric thermoplastic may comprise thermoplastic polyurethane (TPU) and the non-elastomeric thermoplastic comprises polylactic acid (PLA).

The polymer composite material may consist essentially of 10-30 vol. % polylactic acid, 15-30 vol. % thermoplastic polyurethane, 35-70 vol. % magnetic powder, and 0-5 vol. % hexagonal boron nitride.

The polymer composite material may have a relative magnetic permeability of about 20.

It is another object to provide a method of forming a magnetic core for a planar integrated magnetic device, comprising: providing a structure having a bounded aperture; and forming a magnetic core by an additive manufacturing process passing around the structure and through the bounded aperture, thereby capturing the structure.

The additive manufacturing process may employ a filament comprising a metal-polymer composite material for additive manufacturing, comprising: a matrix comprising an elastomeric thermoplastic and a non-elastomeric thermoplastic, and at least 30 vol. % of a magnetically permeable powder.

The forming may comprise: additively manufacturing a lower portion of the magnetic core; placing the structure comprising a circuit board such that the magnetic core extends through the bounded aperture of the circuit board; and additively manufacturing an upper portion of the magnetic core, continuous with the lower portion of the magnetic core, to capture the circuit board.

The structure may comprise a circuit board, and the forming may comprise spinning the circuit board with respect to an additive manufacturing extrusion head, and concurrently extruding the filament with movements of the additive manufacturing extrusion head to form the magnetic core which surrounds the circuit board through the bounded aperture.

The structure may comprise a winding, and the forming may comprise spinning an additive manufacturing machine build plate with respect to an additive manufacturing head, and concurrently moving the additive manufacturing head to form the magnetic core which surrounds the winding through the bounded aperture.

The method may further comprise exposing the magnetically permeable powder to an external magnetic field while the matrix is heated above a fusion temperature, to magnetically align particles the magnetically permeable powder.

The method may further comprise adapting the forming of the magnetic core dependent on at least one magnetic measurement obtained during the additive manufacturing process.

The magnetic core may comprise at least 50 vol. % of a magnetically permeable powder in a matrix comprising at least 10 vol. % elastomeric thermoplastic and at least 10 vol. % non-elastomeric thermoplastic.

It is a still further object to provide a method of forming a metal-polymer composite material for extrusion-based additive manufacturing, comprising: blending thermoplastic polyurethane (TPU), polylactic acid (PLA), and an amorphous or nanocrystalline soft magnetic material, wherein the thermoplastic polyurethane and the polylactic acid form a matrix comprising at least 10 vol. % thermoplastic polyurethane and at least 10 vol. % polylactic acid, and blend comprises at least 30 vol. % amorphous or nanocrystalline soft magnetic material; and extruding the blend into a filament or pellet.

The method may further comprise extruding the filament or pellet in an additive manufacturing process to form an additively manufactured structure; debinding the additively manufactured structure; and sintering the amorphous or nanocrystalline soft magnetic material of the debinded additively manufactured structure.

The amorphous or nanocrystalline soft magnetic material may be Finemet®, Fe—C—Si—Cu —Nb alloy, Metglas amorphous alloy 2605SA1 (Fe₈₁B_{13.5}S_{3.5}C), Metglas 2826 MB Amorphous Alloy (Fe₄₀Ni₄₀Mo₄B₁₆), Vitroperm 500F (Nanocrystalline Fe-based alloy) with B, Si, Nb, Cu, or the like.

It is also an object to provide a metal-polymer composite material for extrusion-based additive manufacturing, comprising: a matrix comprising a mixture of an elastomeric thermoplastic and a non-elastomeric thermoplastic; and at least 50 vol. % of a magnetically permeable powder.

The metal-polymer composite material may comprise 0.5-1 vol. % hBN, 1-2 vol. % hBN, 2-3 vol. % hBN, 3-4 vol. % hBN, 4-5 vol. % hBN, further comprising 4-5 vol. % of hexagonal boron nitride.

The metal-polymer composite material may comprise copper powder.

The metal-polymer composite material may consist essentially of the elastomeric thermoplastic, the non-elastomeric thermoplastic, and the magnetically permeable powder.

The metal-polymer composite material may include 35 vol. % to 40 vol. %, 40 vol. % to 45 vol. %, 45 vol. % to 50 vol, %, 50 vol. % to 55 vol. %, 55 vol. % to 60 vol. %, 60 vol. % to 65 vol. %, 65 vol. % to 67.5 vol. %, 67.5 vol. % to 70 vol. %, 70 vol. % to 71 vol. %, 71 vol. % to 72 vol. %, 72 vol. % to 73 vol. %, 73 vol. % to 74 vol. %, or 74 vol. % to 75 vol. %, magnetically permeable powder.

The metal-polymer composite material may be configured as a continuous filament on a spool, e.g., 1.75 mm diameter, 2.86 mm diameter, or 3 mm (nominal) diameter.

The magnetically permeable powder may comprise Finemet® Fe—C—Si—Cu—Nb alloy.

The elastomeric thermoplastic may comprise thermoplastic polyurethane (TPU).

The non-elastomeric thermoplastic may comprise polylactic acid (PLA).

The metal-polymer composite material may consist essentially of 29.75 vol. % polylactic acid, 29.75 vol. % thermoplastic polyurethane, 39.5 vol. % magnetic powder, and 1 vol. % hexagonal boron nitride.

The metal-polymer composite material may consist essentially of 27.25 vol. % polylactic acid, 27.25 vol. % thermoplastic polyurethane, 44.5 vol. % magnetic powder, and 1 vol. % hexagonal boron nitride.

The metal-polymer composite material may consist essentially of 24.75 vol. % polylactic acid, 24.75 vol. % thermoplastic polyurethane, 49.5 vol. % magnetic powder, and 1 vol. % hexagonal boron nitride.

The metal-polymer composite material may consist essentially of 10 vol. % polylactic acid, 30 vol. % thermoplastic polyurethane, and 60 vol. % magnetic powder.

The metal-polymer composite material may consist essentially of 13.21 vol. % polylactic acid, 21.79 vol. % thermoplastic polyurethane, and 65 vol. % magnetic powder.

The metal-polymer composite material may consist essentially of 10 vol. % polylactic acid, 20 vol. % thermoplastic polyurethane, and 70 vol. % magnetic powder.

The metal-polymer composite material may have a relative magnetic permeability of about 20.

The metal-polymer composite material may have a thermal conductivity of at least 1 W/m-K.

### BRIEF DESCRIPTION OF THE DRAWINGS

FIG. 1A shows a perspective view of an integrated transformer on a printed circuit board (PBC); the left, center and right cores have different geometries.

FIG. 1B shows an equivalent circuit to the circuit of FIG. 1A.

FIG. 2 shows a toroidal core inductor surrounding a printed circuit board that has metal (e.g., copper) winding traces through multiple layers of the board.

FIG. 3 shows a schematic construction of the toroidal core (in this case having a rectangular cross section), and showing that it is manufactured in two parts, allowing the printed circuit board containing windings to be inserted before completion of manufacture of the solid core.

FIG. 4 shows a table of correspondence between symbol and Composition.

FIG. 5 shows a graph of Filament Composition (vol. %) vs. Ultimate Tensile Strength (MPa).

FIG. 6 shows a graph of Filament Composition (vol. %) vs. Young's Modulus (MPa)

FIG. 7 shows a graph of Filament Composition (vol. %) vs. Elongation at Fracture (m/m).

FIG. 8 shows a graph of Filament Composition (vol. %) vs. Thermal Conductivity (W/m·K).

### DETAILED DESCRIPTION OF THE PREFERRED EMBODIMENTS

### Example 1

A filament was formed using a polymer mixture of polylactic acid (PLA) and thermoplastic polyurethane (TPU), mixed with up to 70 vol. % of FINEMET® (Fe—C—Si—Cu—Nb).

The filament was produced using a blend of pulverized thermoplastic polyurethane (TPU), pulverized and pelletized polylactic acid (PLA), hexagonal boron nitride (hBN), and nanocrystalline FINEMET Fe-based soft magnetic material (Fe—C—Si—Cu—Nb). The material was made from pelletized and pulverized PLA from Filabot® (density of 1.24 g/cm³), pulverized TPU is from STSinks® (1.2 g/cm³), and hBN (2.1 g/cm³).

FIGS. 5-8 show each of the FINEMET volume percentage formulations made, compared to commercially available High Carbon Iron (HCl) Filament, which contains ~65 vol. % of metal and has a density of 2.75 g/cm³.

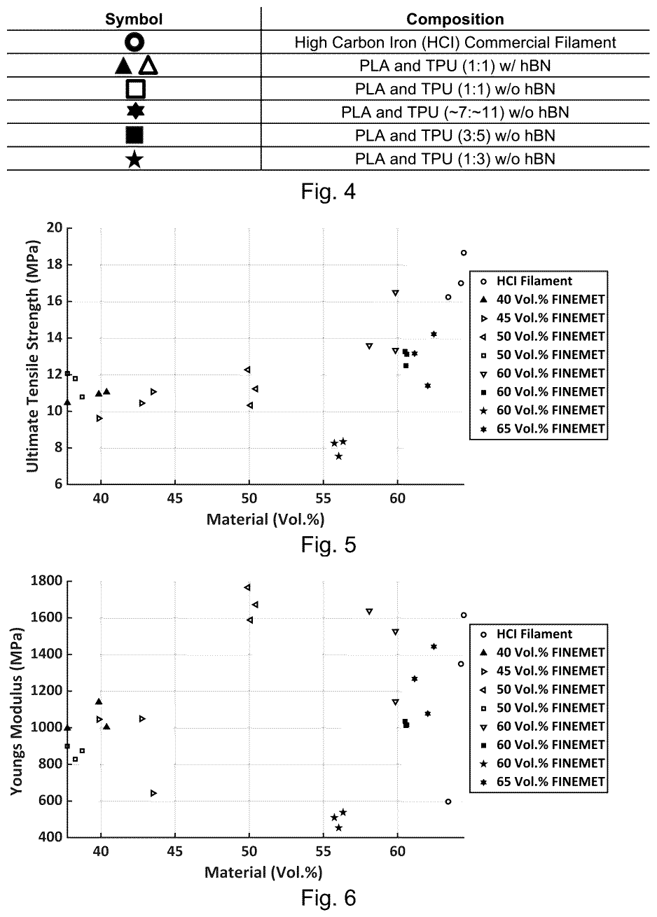

FIG. 4 shows a table of Symbol/Color and Composition.

FIG. 5 shows Filament Composition (vol. %) vs. Ultimate Tensile Strength (MPa).

FIG. 6 shows Filament Composition (vol. %) vs. Young's Modulus (MPa).

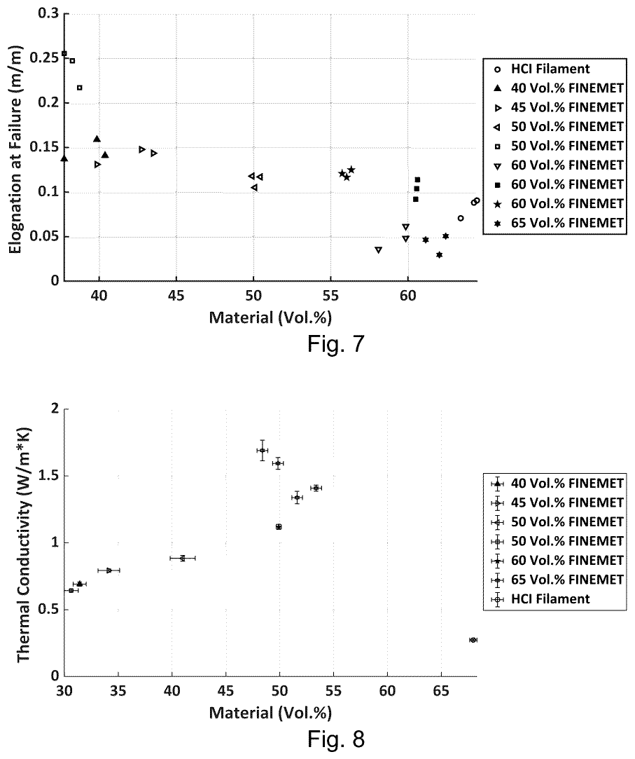

FIG. 7 shows Filament Composition (vol. %) vs. Elongation (m/m).

The graphs allow for a comparison of the various formulas developed with one of the commercially available filaments. In particular, it is noted that the Elongation at fracture for 60 vol. % is higher than the commercial filaments. However, it's revealed that the ultimate tensile strength (UTS) and Young's modulus (YM) for the formulated filaments are far lower than the commercially available results. This is correlated to the higher elastic capability that the formulated filament, which is shown by the higher strain capability (elongation at fracture).

### Example 2

The FINEMET®-PLA-TPU composite material of Example 1 was synthesized and used in an FDM process to manufacture a transformer core around a PCB winding with an inductance of ~7.6 mH.

A Filabot EX2 extruder, with an extruder temperature of 185° C., was used for extruding the composite material. The achievable speed varies depending on the brittleness of the material, and is set within a range to maintain the filament diameter.

In the case of 40 vol. %, the operating speed for the extruder was found to be 50%, which kept its form and automatically rolls the spool. These speeds change as the volume percent (vol. %) of FINEMET in the filament increased, for example, the spooling speed for 50 vol. % was 40%, with an extrusion speed decreased to ~30%. However, when the 60 vol. % range was reached the ability to make a spool of filament diminished, and the filament was forced to be gathered outside of a spool. This was due to the very noticeable brittleness of the filament. Due to this sudden change in the filament structure, the formula to obtain the desired filament had to be altered to a different form as shown in Table 1.

TABLE 1
Weight and Volume Percentages for each material of composite filament

| | | Batch ID Number | | | | | |
|---|---|---|---|---|---|---|---|
| Material | Percentages | 40v001 | 45v001 | 50v001 | 60v003 | 65v002 | 70v001 |
| PLA | | 29.75 | 27.25 | 24.75 | 10.00 | 13.21 | 10.00 |
| | Wt % | 10.16 | 8.59 | 7.24 | 2.55 | 3.15 | 2.27 |
| TPU | vol. % | 29.75 | 27.25 | 24.75 | 30.00 | 21.79 | 20.00 |
| | Wt % | 9.83 | 8.31 | 7.01 | 7.40 | 5.06 | 4.70 |
| FINEMET | vol. % | 39.50 | 44.5 | 49.5 | 60.00 | 65.00 | 70.00 |
| | Wt % | 79.43 | 82.57 | 85.26 | 90.05 | 91.79 | 93.35 |
| hBN | vol. % | 1.00 | 1.00 | 1.00 | 0 | 0 | 0 |
| | Wt % | 0.58 | 0.53 | 0.50 | 0 | 0 | 0 |

### Example 3

When 65 vol. % and 70 vol. % of metal fill were reached, the EX2 extruder was no longer the adequate machine for the much denser composite filament, and it was replaced with the Filabot EX6 (Industrial edition). The EX6 shown introduces several necessary improvements to the extruding process: 4 heating zones help ensure that the entirety of the material is processed, and the higher torque and motor strength mean that the denser material would be able to be successfully extruded. The following table details the composition of various batches with varying compositions [7].

### Example 4

The toroid shaped magnetic core models for 3D printing were designed and modelled in Creo Parametric, then transferred and imported into Creality Slicer 4.8.2 software to produce the G-code (.gcode). With 100% infill speed at 50 mm/s, only supports are placed at the bottom of the printed part to seat the toroid on the build plate.

The parts were printed with a Creality Ender-3 Si Pro printer, with nozzle temperatures ranging from 220-235° C. depending on the FINEMET volume percent. For filaments that had higher vol. % of TPU, the printing temperature was set to 215-220° C. to avoid burning of the TPU.

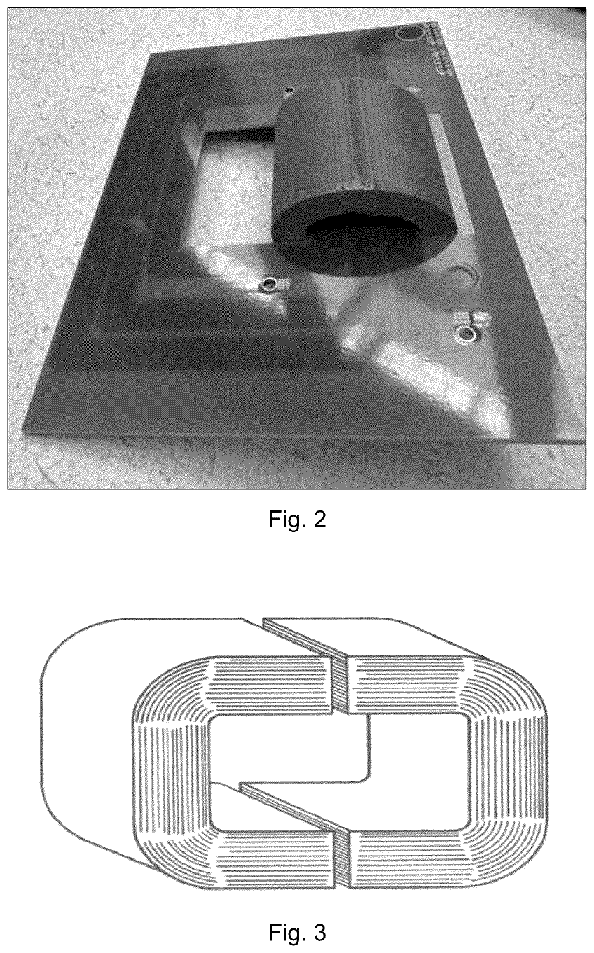

The dimensions used for the toroid part were chosen to be printable through the PCB board, as shown in FIG. 2.

The supports can be printed in non-magnetic material and filament; however, the Creality Ender-3 S1 Pro printer is limited to a single filament at a time, making material changes inefficient. Once the 3D print has reached a “midway” point, representing the separation of halve shown in FIG. 3, the print is paused, and the PCB board is placed into the print such that the remainder of the print can surround the PCB, and then the print resumed.

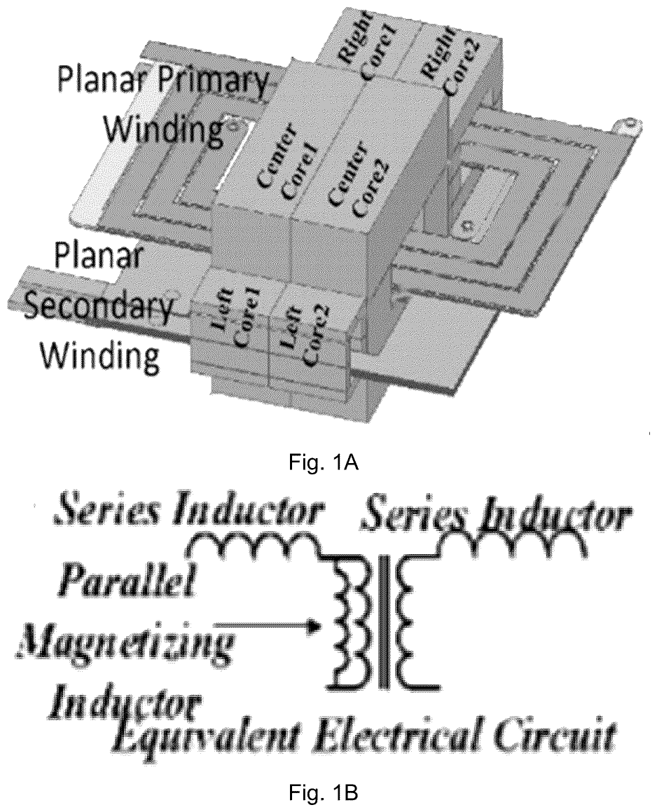

The FDM printing method allows the PCB to be “Embedded” into the 3D printed part, in contrast to conventional methods where the part would need to be built, then cut, and finally bonded together. FIG. 1 shows the PCB board embedded into the oval core.

Permeability Results: The three circular toroids were tested with 40 turns, and the permeability is shown in Table 2.

TABLE 2
Permeability of Circular Toroids for 65 vol. %

| Toroid Number and | Relative Permeability |
|---|---|
| Print Direction/Infill | (unitless.) |
| T1 (Horizontal/Mesh infill) | 15 |
| T2 (Horizontal/Line infill) | 20 |
| T3 (Vertical/Line infill) | 11 |

Table 2 confirms the literature findings of higher permeability due to powder orientation, and the lowest permeability was revealed to be the vertical printed samples. This can be primarily correlated to the layering of the filament, with the powder alignment being in the direction of the extrusion, which thus affects the permeability. Using data from the literature, an applied magnetic field during extrusion may aid in producing a stable connection between layers allowing for a permeability increase. This would require a magnetic field that would force the particles to move closer and remove the polymer film separating them [11], [12].

To find the most optimal print format for the implication of higher permeability, circular toroids as shown in FIG. 2 were printed. These allowed for quicker printing times and to get the required permeability much more rapidly.

Three prints for the 65 vol. % (65 v002); Horizontal with mesh infill, vertical with line infill, and horizontal with line infill were made. Line infill for the horizontal build allowed the extrusion path to be parallel to the application's toroid magnetic field lines. The meshing infill produced a crisscrossed mesh where alternating z-layers have perpendicular extrusion path. Literature suggests that the permeability in the direction of extrusion is higher due to alignment of particles along that direction [4], [10]. It is also reported that forced particle alignment such as applying a magnetic field to the extruding portion of the printer allows for the particles to face the desired direction further increasing the permeability [11].

An alternative embodiment captures the board that is positioned vertically in the X-Z plane, with the buildplate rotating through the board. The printhead is positioned with motion in the radial direction (Y) and z-directions. This method aligns the printed roads with the magnetic field lines.

In other embodiments the printed magnetic core is captured in the vertical orientation, and the printed wiring board or windings are placed around midway in the printing.

In some embodiments the printed magnetic core can be fed through the windings, so to be captured in the windings. The windings can take the form of lithe wire or a printed wiring (PWB) or printed circuit board (PCB). The lithe wire can be pre-wrapped around a dummy form. The PCB or PWB can be made of different forms, including FR4 or ceramic. Ceramics can have the advantage of surviving an anneal or sintering step, if needed. In some applications printed materials can be extruded into a small through hole in the PCB/PWB and captured by extrusion into the hole.

### Example 5

The printing around the PCB method can allow stopping the print when exactly the desired inductance is achieved.

Therefore, a feedback system may be employed to measure the electromagnetic performance of the core during manufacture. For example, after the circuit board is inserted, the printed coils may be active, and the inductance measured periodically or in real time. If there are multiple coils, see e.g., FIGS. 1A and 1B, each core structure can be individually calibrated, or the composite structure tuned for optimal operation. Typically, the tuning is achieved after the respective core forms a closed loop, and therefore feedback may be limited to the time after the structure has a nominal configuration. The printed toroid can be made around a spool that acts as a rotational build plate upon which a core is formed. The spool is rotated so that the extrusion printer can print a core with alignment in the direction of the magnetic field. The spool can be a structure that connects together to form a structure through a PCB cutout.

The tuning may also be achieved by optical (e.g., video) or mechanical inspection of the part, or separate excitation of magnetic fields independent of the PCB. The operative coils of the PCB need not be energized, and the PCB may have an auxiliary coil to provide manufacturing feedback. The auxiliary coil may be a temporary or permanent structure.

Alternately, the core may be tuned after FDM manufacture using another additive manufacturing or subtractive manufacturing, and/or thermal process, possibly in the presence of a magnetic field.

### Example 6

Thermal diffusivity and thermal conductivity were ascertained using Flash Diffusivity (Anter, Flashline 2000). The filaments were printed into small 12 mm×12 mm×1 mm test coupons. These coupons were coated in a thin layer of aerosol carbon. Ten experiments were done on 4 coupons of the same filament content.

FIG. 8 shows a graph of Filament Composition (vol. %) vs. Thermal Conductivity (W/m·K). FIG. 8 thus shows an increase in thermal conductivity as the metal content increases. The ~30 vol. % with and without hBN shows a difference of about ~0.5 W/m·K (~7% enhancement), but at the expense of harder printability. The 50 vol. % sample reveals that the distance between the particles has greatly decreased, which allows for the thermal conductivity to be enhanced by the lower inter-particle thermal resistance and higher concentration of metallic particles.

### CONCLUSION

Ultimately, several materials, thermal, and magnetic attributes are affected by the increased vol. % of FINEMET® within the filament. In mechanical testing, a correlation between the higher FINEMET® vol. % and the material's Ultimate tensile strength, Young's modulus, and elongation at fracture are all affected. In the 60 vol. % formulas, the desired aspect was the ability to spool the filament, so this meant increasing the TPU to compensate for the increased brittleness caused by the higher vol. % of FINEMET®. This however also led to lower YM and UTS, because of the more elastic behavior; the higher elongation at fracture is a testament to the higher TPU in the composite.

The thermal conductivity data shows that hBN can aid in producing higher thermal conductive composite material, however, because hBN is a 2D material, this would also increase the overall filament brittleness. So, when the hBN was removed the thermal conductivity dropped, which was later rectified with the increase of FINEMET where it achieved ~1.1 W/m·K for 60 vol. %.

The permeability of the horizontal line infill toroid (T2) was the highest permeability orientation.

### REFERENCES

[1] X. Wei, M.-L. Jin, H. Yang, X.-X. Wang, Y.-Z. Long, and Z. Chen, “Advances in 3D printing of magnetic materials: Fabrication, properties, and their applications,” J. Adv. Ceram., vol. 11, no. 5, pp. 665-701, May 2022, doi: 10.1007/s40145-022-0567-5.
[2] T. Hanemann, D. Syperek, and D. Notzel, “3D Printing of ABS Barium Ferrite Composites,” Materials, vol. 13, no. 6, p. 1481, Mar. 2020, doi: 10.3390/ma13061481.
[3] T. Polygenis, “A Comprehensive Guide to PLA Melting Point and How it Influences 3D Printing.” Accessed: Jan. 3, 2024. [Online]. Available: https://www.wevolver.com/article/a-comprehensive-guide-to-pla-melting-point-and-how-it-influences-3d-printing
[4] J. Liu, W. Li, Y. Guo, H. Zhang, and Z. Zhang, “Improved thermal conductivity of thermoplastic polyurethane via aligned boron nitride platelets assisted by 3D printing,” Compos. Part Appl. Sci. Manuf., vol. 120, pp. 140-146, May 2019, doi: 10.1016/j.compositesa.2019.02.026.
[5] Z.-M. Zhou, K. Wang, K. Lin, Y.-H. Wang, and J.-Z. Li, “Influence of Characteristics of Thermoplastic Polyurethane on Graphene-Thermoplastic Polyurethane Composite Film,” Micromachines, vol. 12, no. 2, p. 129, Jan. 2021, doi: 10.3390/mi12020129.
[6] H. Tiismus, A. Kallaste, A. Belahcen, A. Rassolkin, T. Vaimann, and P. Shams Ghahfarokhi, “Additive Manufacturing and Performance of E-Type Transformer Core,” Energies, vol. 14, no. 11, p. 3278, Jun. 2021, doi: 10.3390/en14113278.
[7] “Filament Maker—Recycle Filament for Any 3D Printer,” Filabot. Accessed: Jan. 3, 2024. [Online]. Available: https://www.filabot.com/
[8] J. McFARLANE, “SILICON STEEL SHEETS—AN OUTLINE OF PROPERTIES, APPLICATIONS AND RECENT DEVELOPMENTS”.
[9] S. Wang, H. He, X. Ye, R. Chen, Q. Li, and B. Huang, “Design of rGO-BN hybrids for enhanced thermal management properties of polyurethane composites fabricated by 3D printing,” Compos. Sci. Technol., vol. 227, p. 109591, Aug. 2022, doi: 10.1016/j.compscitech.2022.109591.
[10] C. Huber et al., “3D Printing of Polymer-Bonded Rare-Earth Magnets With a Variable Magnetic Compound Fraction for a Predefined Stray Field,” Sci. Rep., vol. 7, no. 1, p. 9419, Aug. 2017, doi: 10.1038/s41598-017-09864-0.
[11] M. Suppan et al., “In-situ alignment of 3D printed anisotropic hard magnets,” Sci. Rep., vol. 12, no. 1, p. 17590, Oct. 2022, doi: 10.1038/s41598-022-20669-8.
[12] T. M. Calascione, N. A. Fischer, T. J. Lee, H. G. Thatcher, and B. B. Nelson-Cheeseman, “Controlling magnetic properties of 3D-printed magnetic elastomer structures via fused deposition modeling,” AIP Adv., vol. 11, no. 2, p. 025223, Feb. 2021, doi: 10.1063/9.0000220.
Ralchev, Martin, Valentin Mateev, and Iliana Marinova. “Magnetic properties of FFF/FDM 3D printed magnetic material.” In 2021 17th Conference on Electrical Machines, Drives and Power Systems (ELMA), pp. 1-5. IEEE, 2021.
Fischer, Nathan A., Alex L. Robinson, Thomas J. Lee, Thomas M. Calascione, Lucas Koerner, and Brittany B. Nelson-Cheeseman. “Magnetic annealing of extruded thermoplastic magnetic elastomers for 3D-Printing via FDM.” Journal of Magnetism and Magnetic Materials 553 (2022): 169266.
Ralchev, Martin, Valentin Mateev, and Iliana Marinova. “3D printing of magnetic materials by FFF technology.” In 2020 12th Electrical Engineering Faculty Conference (BulEF), pp. 1-4. IEEE, 2020.
Amirov, Abdulkarim, Alexander Omelyanchik, Dmitry Murzin, Valeria Kolesnikova, Stanislav Vorontsov, Ismel Musov, Khasan Musov, Svetlana Khashirova, and Valeria Rodionova. “3D printing of PLA/magnetic ferrite composites: effect of filler particles on magnetic properties of filament.” Processes 10, no. 11 (2022): 2412.
Calascione, Thomas M., Nathan A. Fischer, Thomas J. Lee, Hannah G. Thatcher, and Brittany B. Nelson-Cheeseman. “Controlling magnetic properties of 3D-printed magnetic elastomer structures via fused deposition modeling.” AIP Advances 11, no. 2 (2021).
Diaz-Garcia, Alvaro, Jia Yan Law, Manuel Felix, Antonio Guerrero, and Victorino Franco. “Functional, thermal and rheological properties of polymer-based magnetic composite filaments for additive manufacturing.” Materials & Design 219 (2022): 110806.
Bollig, Lindsey M., Peter J. Hilpisch, Greg S. Mowry, and Brittany B. Nelson-Cheeseman. “3D printed magnetic polymer composite transformers.” Journal of Magnetism and Magnetic Materials 442 (2017): 97-101.
Khatri, Bilal, Karl Lappe, Dorit Noetzel, Kilian Pursche, and Thomas Hanemann. “A 3D-printable polymer-metal soft-magnetic functional composite-Development and characterization.” Materials 11, no. 2 (2018): 189.
Ehrmann, Guido, Tomasz Blachowicz, and Andrea Ehrmann. “Magnetic 3D-printed composites—production and applications.” Polymers 14, no. 18 (2022): 3895.
Chaudhary, V., S. A. Mantri, R. V. Ramanujan, and R. Banerjee. “Additive manufacturing of magnetic materials.” Progress in Materials Science 114 (2020): 100688.
Lamichhane, Tej Nath, Latha Sethuraman, Adrian Dalagan, Haobo Wang, Jonathan Keller, and M. Parans Paranthaman. “Additive manufacturing of soft magnets for electrical machines—A review.” Materials Today Physics 15 (2020): 100255.
Díaz-García, Álvaro, Jia Yan Law, Manuel Felix, Antonio Guerrero, and Victorino Franco. “Functional, thermal and rheological properties of polymer-based magnetic composite filaments for additive manufacturing.” Materials & Design 219 (2022): 110806.
Díaz-García, Álvaro, Jia Yan Law, Agustín Cota, A. Bellido-Correa, Joaquín Ramírez-Rico, Richard Schäfer, and V. Franco. “Novel procedure for laboratory scale production of composite functional filaments for additive manufacturing.” Materials Today Communications 24 (2020): 101049.
Park, Jungjin, Andrew Becnel, Alison B. Flatau, and Norman Wereley. “Magnetic particle reinforced elastomer composites for additive manufacturing.” IEEE Transactions on Magnetics 58, no. 2 (2021): 1-5.
Vincent, Martin, Gillon Frédéric, Najjar Denis, Benabou Abdelkader, Witz Jean-François, Hecquet Michel, and Quaegebeur Philippe. “Additive manufacturing for soft magnetic materials.” In 2021 IEEE International Magnetic Conference (INTERMAG), pp. 1-5. IEEE, 2021.
Yan, Yi, Khai D T Ngo, Yuhui Mei, and Guo-Quan Lu. “Additive manufacturing of magnetic components for power electronics integration.” In 2016 International Conference on Electronics Packaging (ICEP), pp. 368-371. IEEE, 2016.
Yan, Yi, Lanbing Liu, Chao Ding, Luu Nguyen, Jim Moss, Yunhui Mei, and Guo-Quan Lu. “Additive manufacturing of magnetic components for heterogeneous integration.” In 2017 IEEE 67th Electronic Components and Technology Conference (ECTC), pp. 324-330. IEEE, 2017.
Li, Ling, Kodey Jones, Brian Sales, Jason L. Pries, I. C. Nlebedim, Ke Jin, Hongbin Bei et al. “Fabrication of highly dense isotropic Nd—Fe—B nylon bonded magnets via extrusion-based additive manufacturing.” Additive Manufacturing 21 (2018): 495-500.
Bowen, David, and Debtanu Basu. “Exploration of the 3-D printing of transformer structures with embedded ferrite cores.” IEEE Transactions on Magnetics 55, no. 2 (2018): 1-5.
Ding, Chao, Lanbing Liu, Yunhui Mei, Khai D T Ngo, and Guo-Quan Lu. “Magnetic paste as feedstock for additive manufacturing of power magnetics.” In 2018 IEEE Applied Power Electronics Conference and Exposition (APEC), pp. 615-618. IEEE, 2018.
Duhaj, Pavol, Igor Mat'ko, Peter S̆vec, and Dus̆an Janic̆kovic̆. “Structural characterization of the finemet type alloys.” Journal of non-crystalline solids 192 (1995): 561-564.
Duhaj, Pavol, Peter S̆vec, Dus̆an Janic̆kovic̆, Igor Mat'ko, and Martin Hlásnik. “Structure and magnetic properties of the Finemet alloy Fe73Cu1Nb3Si13. 5B9. 5.” Materials Science and Engineering: B 14, no. 4 (1992): 357-364.
Kumar, M. Bhuvanesh, and P. Sathiya. “Methods and materials for additive manufacturing: A critical review on advancements and challenges.” Thin-Walled Structures 159 (2021): 107228.
Lamichhane, Tej Nath, Latha Sethuraman, Adrian Dalagan, Haobo Wang, Jonathan Keller, and M. Parans Paranthaman. “Additive manufacturing of soft magnets for electrical machines—A review.” Materials Today Physics 15 (2020): 100255.
Lashgari, H. R., M. Ferry, and S. Li. “Additive manufacturing of bulk metallic glasses: Fundamental principle, current/future developments and applications.” Journal of Materials Science & Technology 119 (2022): 131-149.
Lu, Wei, Biao Yan, and Wen-hai Huang. “Complex primary crystallization kinetics of amorphous Finemet alloy.” Journal of non-crystalline solids 351, no. 40-42 (2005): 3320-3324.
Menicanin, Aleksnadar, Miloljub Lukovic, Nelu Blaz, and Ljiljana Zivanov. “Design and fabrication of ferrite inductor using 3D printed spiral coil and ferrite disc.” In IEEE EUROCON 2019-18th International Conference on Smart Technologies, pp. 1-4. IEEE, 2019.
Mushnikov, N. V., A. P. Potapov, D. A. Shishkin, A. V. Protasov, O. A. Golovnya, N. N. Shchegoleva, V. S. Gaviko et al. “Magnetic properties and structure of nanocrystalline FINEMET alloys with various iron contents.” The Physics of Metals and Metallography 116 (2015): 663-670.
Muthu, Vivek, Pradip Chatterjee, and Tseng King Jet. “Review on application of additive manufacturing for electrical power converters.” In 2016 IEEE Region 10 Conference (TENCON), pp. 2327-2333. IEEE, 2016.
Périgo, E. A., J. Jacimovic, F. García Ferré, and L. M. Scherf. “Additive manufacturing of magnetic materials.” Additive Manufacturing 30 (2019): 100870.
Raja, M. Manivel, K. Chattopadhyay, B. Majumdar, and A. Narayanasamy. “Structure and soft magnetic properties of Finemet alloys.” Journal of Alloys and Compounds 297, no. 1-2 (2000): 199-205.
Rodriguez-Vargas, Bryan Ramiro, Giulia Stornelli, Paolo Folgarait, Maria Rita Ridolfi, Argelia Fabiola Miranda Pérez, and Andrea Di Schino. “Recent advances in additive manufacturing of soft magnetic materials: A review.” Materials 16, no. 16 (2023): 5610.
Szabó, Loránd, and Dénes Fodor. “The key role of 3D printing technologies in the further development of electrical machines.” Machines 10, no. 5 (2022): 330.
Talaat, A., M. V. Suraj, K. Byerly, A. Wang, Y. Wang, J. K. Lee, and P. R. Ohodnicki Jr. “Review on soft magnetic metal and inorganic oxide nanocomposites for power applications.” Journal of Alloys and Compounds 870 (2021): 159500.
Vincent, Martin, Gillon Frédéric, Najjar Denis, Benabou Abdelkader, Witz Jean-François, Hecquet Michel, and Quaegebeur Philippe. “Additive manufacturing for soft magnetic materials.” In 2021 IEEE International Magnetic Conference (INTERMAG), pp. 1-5. IEEE, 2021.
Wang, Haobo. “Additive Manufacturing of Magnetic Materials for Electric Motor and Generator Applications.” (2023).
Xu, Yue, and Cheng Deng. “An investigation on 3D printing technology for power electronic converters.” In 2017 IEEE 8th International Symposium on Power Electronics for Distributed Generation Systems (PEDG), pp. 1-6. IEEE, 2017.
Yan, Yi, Chao Ding, Khai D T Ngo, Yuhui Mei, and Guo-Quan Lu. “Additive manufacturing of planar inductor for Power Electronics applications.” In 2016 International Symposium on 3D Power Electronics Integration and Manufacturing (3D-PEIM), pp. 1-16. IEEE, 2016.
Yan, Yi, Jim Moss, Khai D T Ngo, Yunhui Mei, and Guo-Quan Lu. “Additive manufacturing of toroid inductor for power electronics applications.” IEEE Transactions on Industry Applications 53, no. 6 (2017): 5709-5714.
Yan, Yi, Khai D T Ngo, Yuhui Mei, and Guo-Quan Lu. “Additive manufacturing of magnetic components for power electronics integration.” In 2016 International Conference on Electronics Packaging (ICEP), pp. 368-371. IEEE, 2016.
Yan, Yi, Lanbing Liu, Chao Ding, Luu Nguyen, Jim Moss, Yunhui Mei, and Guo-Quan Lu. “Additive manufacturing of magnetic components for heterogeneous integration.” In 2017 IEEE 67th Electronic Components and Technology Conference (ECTC), pp. 324-330. IEEE, 2017.
Yan, Yi. “Design methodology and materials for additive manufacturing of magnetic components.” PhD diss., Virginia Tech, 2017.
Thavornyutikarn, Boonlom, Chuanchom Aumnate, Wasana Kosorn, Nutdanai Nampichai, and Wanida Janvikul. “Acrylonitrile butadiene styrene/thermoplastic polyurethane blends for material extrusion three-dimensional printing: effects of blend composition on printability and properties.” ACS omega 8, no. 47 (2023): 45013-45025.
Heidari, Farshad, Milad Aghalari, Ata Chalabi Tehran, and Karim Shelesh-Nezhad. “Study on the fluidity, mechanical and fracture behavior of ABS/TPU/CNT nanocomposites.” Journal of Thermoplastic Composite Materials 34, no. 8 (2021): 1037-1051.
de León, A. Sanz, A. Dominguez-Calvo, and S. I. Molina. “Materials with enhanced adhesive properties based on acrylonitrile-butadiene-styrene (ABS)/thermoplastic polyurethane (TPU) blends for fused filament fabrication (FFF).” Materials & Design 182 (2019): 108044.
Soltanmohammadi, Kianoosh, Davood Rahmatabadi, Mohammad Aberoumand, Elyas Soleyman, Ismaeil Ghasemi, Majid Baniassadi, Karen Abrinia, Mahdi Bodaghi, and Mostafa Baghani. “Effects of TPU on the mechanical properties, fracture toughness, morphology, and thermal analysis of 3D-printed ABS-TPU blends by FDM.” Journal of Vinyl and Additive Technology (2024).
Demma, Giovanbattista, Ezio Martuscelli, Alvise Zanetti, and Mauro Zorzetto. “Morphology and properties of polyurethane-based blends.” Journal of Materials Science 18 (1983): 89-102.
Ahad, Nor Azwin. “A Recent blend of thermoplastic polyurethane (TPU).” In IOP Conference Series: Materials Science and Engineering, vol. 957, no. 1, p. 012045. IOP Publishing, 2020.
Zitzumbo, R., F. Avalos, and S. Alonso. “Nanostructural complex in ABS/TPU immiscible mixtures.” Polymers and Polymer Composites 24, no. 3 (2016): 205-212.
Nofar, Mohammadreza, Mojtaba Mohammadi, and Pierre J. Carreau. “Effect of TPU hard segment content on the rheological and mechanical properties of PLA/TPU blends.” Journal of Applied Polymer Science 137, no. 45 (2020): 49387.
Lai, S-M., and Y-C. Lan. “Shape memory properties of melt-blended polylactic acid (PLA)/thermoplastic polyurethane (TPU) bio-based blends.” Journal of Polymer Research 20 (2013): 1-8.
Dogan, Sebnem Kemaloglu, Efren Andablo Reyes, Sanjay Rastogi, and Guralp Ozkoc. “Reactive compatibilization of PLA/TPU blends with a diisocyanate.” Journal of Applied Polymer Science 131, no. 10 (2014).
Fang, Hui, Lingjie Zhang, Anlin Chen, and Fangjuan Wu. “Improvement of mechanical property for PLA/TPU blend by adding PLA-TPU copolymers prepared via in situ ring-opening polymerization.” Polymers 14, no. 8 (2022): 1530.
Feng, Fei, and Lin Ye. “Morphologies and mechanical properties of polylactide/thermoplastic polyurethane elastomer blends.” Journal of Applied Polymer Science 119, no.5 (2011): 2778-2783.
Rahmatabadi, D., I. Ghasemi, M. Baniassadi, K. Abrinia, and M. Baghani. “3D printing of PLA-TPU with different component ratios: Fracture toughness, mechanical properties, and morphology.” Journal of Materials Research and Technology 21 (2022): 3970-3981.
Wei, L. I., X. I. A. Xinshu, L. I. N. Hongyu, Y. A. N. G. Yujin, C. H. E. N. Qinghua, and X. I. A. O. Liren. “Effect of fused deposition style on impact properties of PLA/TPU blends.” China Plastics 33, no. 9 (2019): 21.
Jayswal, Ajay, and Sabit Adanur. “Characterization of polylactic acid/thermoplastic polyurethane composite filaments manufactured for additive manufacturing with fused deposition modeling.” Journal of Thermoplastic Composite Materials 36, no. 4 (2023): 1450-1471.
U.S. Patent and Patent Application Nos. US 20230264258 A1; 20230260687; 20230032553; 20210280767; 20210189374; 20210057149; 20200253096; 20190252099; 10254499; 20180236724; 20180229442; 20180215854; 20180117818; 20180122570; 20170253702; 20240116251; 20200108463; 20180343749; 20230392475; 20230340971; 20230260687; 20230201833; 20230122599; 20220204911; 20220134661; 20210283838; 20210189374; 20210162408; 20210057149; 20200408616; 20200298493; 20200298468; 20200180213; 20200035393; 20190252099; 20180236724; 20180229442; 20180215854; 20180117818; 20180122570; 20180022017; 20180019049; 20170306221; 20170054191; 20170021568; 20160054397; 20140302110; 20130056672; 20110201869; 20100259254; 20100243574; 20100140146; 20020036141; 11,951,683; and 6,858,439.

1. A polymer composite material for extrusion-based additive manufacturing, comprising:
a matrix comprising a mixture of at least 10 vol. % of the matrix of each an elastomeric thermoplastic and a non-elastomeric thermoplastic; and
at least 35 vol. % of a non-polymer powder.

2. The polymer composite material according to claim 1, configured as a continuous filament on a spool.

3. The polymer composite material according to claim 1, further comprising 0.01-5 vol. % of hexagonal boron nitride, wherein the non-polymer powder is sinterable, and the polymer composite material is adapted to be debindered and sintered.

4. The polymer composite material according to claim 1, further comprising copper powder.

5. The polymer composite material according to claim 1, consisting essentially of the elastomeric thermoplastic, the non-elastomeric thermoplastic, and a magnetically permeable powder.

6. The polymer composite material according to claim 1, consisting essentially of the elastomeric thermoplastic, the non-elastomeric thermoplastic, the non-polymer powder comprising a magnetically permeable powder, and between 0.01-5% hexagonal boron nitride.

7. The polymer composite material according to claim 1, wherein the non-polymer powder comprises 50 vol. % to 65 vol. % magnetically permeable powder.

8. The polymer composite material according to claim 1, wherein the non-polymer powder comprises 65 vol. % to 75 vol. % magnetically permeable powder.

9. The polymer composite material according to claim 1, wherein the non-polymer powder comprises Finemet® Fe—C—Si—Cu—Nb alloy.

10. The polymer composite material according to claim 1, wherein the elastomeric thermoplastic comprises thermoplastic polyurethane (TPU) and the non-elastomeric thermoplastic comprises polylactic acid (PLA).

11. The polymer composite material according to claim 1, consisting essentially of 10-30 vol. % polylactic acid, 15-30 vol. % thermoplastic polyurethane, 35-70 vol. % magnetic powder, and 0-5 vol. % hexagonal boron nitride.

12. The polymer composite material according to claim 1, having a relative magnetic permeability of about 20.

13. A method of forming a magnetic core for a planar integrated magnetic device, comprising:
providing a structure having a bounded aperture; and
forming a magnetic core by an additive manufacturing process passing around the structure and through the bounded aperture, thereby capturing the structure.

14. The method according to claim 13, wherein the additive manufacturing process employs a filament comprising a metal-polymer composite material for additive manufacturing, comprising: a matrix comprising an elastomeric thermoplastic and a non-elastomeric thermoplastic, and at least 30 vol. % of a magnetically permeable powder.

15. The method according to claim 13, wherein said forming comprises:
additively manufacturing a lower portion of the magnetic core;
placing the structure comprising a circuit board such that the magnetic core extends through the bounded aperture of the circuit board; and
additively manufacturing an upper portion of the magnetic core, continuous with the lower portion of the magnetic core, to capture the circuit board.

16. The method according to claim 13, wherein the structure comprises a winding, and said forming comprises spinning an additive manufacturing machine build plate with respect to an additive manufacturing head, and concurrently moving the additive manufacturing head to form the magnetic core which surrounds the winding through the bounded aperture.

17. The method according to claim 13, further comprising exposing the magnetically permeable powder to an external magnetic field while the matrix is heated above a fusion temperature, to magnetically align particles the magnetically permeable powder.

18. The method according to claim 13, further comprising adapting the forming of the magnetic core dependent on at least one magnetic measurement obtained during the additive manufacturing process.

19. The method according to claim 13, wherein the magnetic core comprises at least 50 vol. % of a magnetically permeable powder in a matrix comprising at least 10 vol. % elastomeric thermoplastic and at least 10 vol. % non-elastomeric thermoplastic.

20. A method of forming a metal-polymer composite material for extrusion-based additive manufacturing, comprising:
blending thermoplastic polyurethane (TPU), polylactic acid (PLA), and an amorphous or nanocrystalline soft magnetic material, wherein the thermoplastic polyurethane and the polylactic acid form a matrix comprising at least 10 vol. % thermoplastic polyurethane and at least 10 vol. % polylactic acid, and blend comprises at least 30 vol. % of the amorphous or nanocrystalline soft magnetic material; and
extruding the blend into a filament or pellet.

21. The method according to claim 20, further comprising:
extruding the filament or pellet in an additive manufacturing process to form an additively manufactured structure;
debinding the additively manufactured structure; and
sintering the amorphous or nanocrystalline soft magnetic material of the debinded additively manufactured structure.
